(19) United States
(12) Patent Application Publication
(10) Pub. No.: US 2012/0153807 A1
(43) Pub. Date: Jun. 21, 2012

(54) ELECTRODE FOR DISCHARGE LAMP AND MANUFACTURING METHOD THEREOF

(75) Inventors: Shigeo Mikoshiba, Tokyo (JP); Satoru Watanabe, Tokyo (JP); Kazuhiro Ito, Tokyo (JP); Naomichi Miyakawa, Tokyo (JP); Setsuro Ito, Tokyo (JP); Kei Maeda, Tokyo (JP); Yutaka Kuroiwa, Tokyo (JP)

(73) Assignee: Asahi Glass Company, Limited, Tokyo (JP)

(21) Appl. No.: 13/404,923

(22) Filed: Feb. 24, 2012

Related U.S. Application Data
(63) Continuation of application No. PCT/JP2010/064314, filed on Aug. 24, 2010.

(30) Foreign Application Priority Data
Aug. 25, 2009 (JP) 2009-194798

(51) Int. Cl. H01J 61/06; H01J 1/142; H01J 9/02

(52) U.S. Cl. 313/491; 445/48; 252/518.1; 252/515; 252/512

(57) ABSTRACT

An electrode for a fluorescent lamp includes a filament and an emitter provided on the filament. The emitter includes a mayenite compound.

### CROSS-REFERENCE TO RELATED APPLICATIONS

This application is a U.S. continuation application, filed under 35 USC 111(a) and claiming the benefit under 35 USC 120 and 365(c), of PCT application JP2010/064314 filed Aug. 24, 2010. The foregoing application is hereby incorporated herein by reference.

### FIELD

The present invention relates to a discharge lamp and, more particularly, to a thermal cathode fluorescent lamp.

### BACKGROUND

Fluorescent lamps are widely used for applications, such as an illumination, a backlight of a display device, and light irradiation in various production processes.

From among fluorescent lamps, it is common that a filament made of tungsten or molybdenum is especially used for an electrode of a hot cathode fluorescent lamp. However, in a usual case, in order to raise a starting characteristic and lamp efficiency of the fluorescent lamp, the filament is covered by an electron emission material, which is referred to as an emitter. The emitter has a function of lowering a work function of an electrode to promote thermal electron emission at the time of discharge. As such an emitter material, alkaline earth metal oxides, such as barium oxide (BaO), strontium oxide (SrO), or calcium oxide (CaO), etc., are usually used (for example, refer to Japanese Laid-Open Patent Application No. 2007-305422).

However, in a fluorescent lamp having such an electrode, it has been pointed out that there is a problem of an emitter being consumed with duration of use. It is considered that this is because (1) an alkaline earth metal oxide usually has a high vapor pressure at a high temperature, and (2) adhesiveness between an alkaline earth metal oxide and a filament is not good. That is, an emitter may be consumed for a relatively short period because an emitter heated at a high-temperature may be evaporated during use of the fluorescent lamp due to an influence of (1), and an emitter may be omitted from a filament due to an influence of (2).

If such a consumption of an emitter occurs, there may be a problem in that a light-emitting efficiency (more specifically, a thermal electron emission efficiency) is decreased. Additionally, if consumption of an emitter becomes severe, a part of a filament may be exposed, and, thereby, a burnout of an electrode may occur easily. As a result, there may be a problem that a service life of the fluorescent lamp is shortened.

### SUMMARY

It is a general object of the present invention to provide an electrode for a fluorescent lamp, which can eliminate the above-mentioned problems.

A more specific object of the present invention is to provide an electrode for a fluorescent lamp, which suppresses consumption of an emitter and is usable stably for a long time, and a fluorescent lamp equipped with such an electrode, and also to provide a manufacturing method of such an electrode.

In order to achieve the above-mentioned object, there is provided according to one aspect of the present invention an electrode for a fluorescent lamp, including: a filament; and an emitter provided on the filament, wherein the emitter includes a mayenite compound.

In the above-mentioned electrode, the mayenite compound may include a conductive mayenite. The emitter may further contain an alkaline earth metal oxide. The alkaline earth metal oxide may include at least one kind of oxide selected from a group consisting of barium oxide (Bao), strontium oxide (SrO) and calcium oxide (CaO). The filament may contain tungsten (W) or molybdenum (Mo).

Additionally, there is provided according to another aspect of the present invention a fluorescent lamp, including: a bulb having an internal space in which mercury and a rare gas are filled; a phosphor provided on an inner surface of the bulb; and an electrode that causes a discharge to be generated and maintained in the internal space, wherein the electrode is the above-mentioned electrode.

Further, there is provided according to another aspect of the present invention a manufacturing method of an electrode for a fluorescent lamp, including: a step of preparing a filament; and a step of providing an emitter containing a mayenite compound on the filament.

In the above-mentioned manufacturing method, the step of providing the emitter may include: a step of preparing a slurry containing a powder of the mayenite compound; and a step of heating the filament after providing the slurry on the filament, and causing to sinter the powder of the mayenite compound. The mayenite compound may include a conductive mayenite. The filament may contain tungsten (W) or molybdenum (Mo).

Other objects, features and advantages of the present invention will become more apparent from the following detailed description when read in conjunction with the accompanying drawings.

### BRIEF DESCRIPTION OF THE DRAWINGS

FIG. 1 is an enlarged view of a partially cut-away cross-sectional view illustrating an outline example of a fluorescent lamp according to the present invention;

FIG. 2 is an illustration schematically illustrating an example of a structure of an electrode;

FIG. 3 is a view schematically illustrating a structure (a double coil structure) of a filament of the electrode;

FIG. 4 is a view schematically illustrating another structure (a triple coil structure) of a filament of the electrode;

FIG. 5 is a view schematically illustrating the filament of which emitter is coated;

FIG. 6 is a flowchart illustrating an example of a method for manufacturing an electrode according to the present invention;

FIG. 7 is a SEM photograph illustrating a cross-sectional configuration of the electrode according to a practical example 1 after an arc-discharge test;

FIG. 8 is a graph indicating tube current-tube voltage characteristics of a lamp B5 and a lamp C1 in a practical example 5 and a comparative example 2.

FIG. 9 is graph indicating filament temperatures and firing voltages of the lamp B5 and the lamp C1 in a practical example 6 and a comparative example C1.

FIG. 10 is a photograph illustrating aspects of bulbs 30 of a lamp B6, a lamp C2 and a lamp D1 in a practical example 7.

FIG. 11 is a graph indicating a relationship between Ar energy and sputtering rate when Ar is incident on BaO or a mayenite compound.

### DETAILED DESCRIPTION OF THE PREFERRED EMBODIMENTS

A description will be given below, with reference to the drawings, of modes of the present invention.

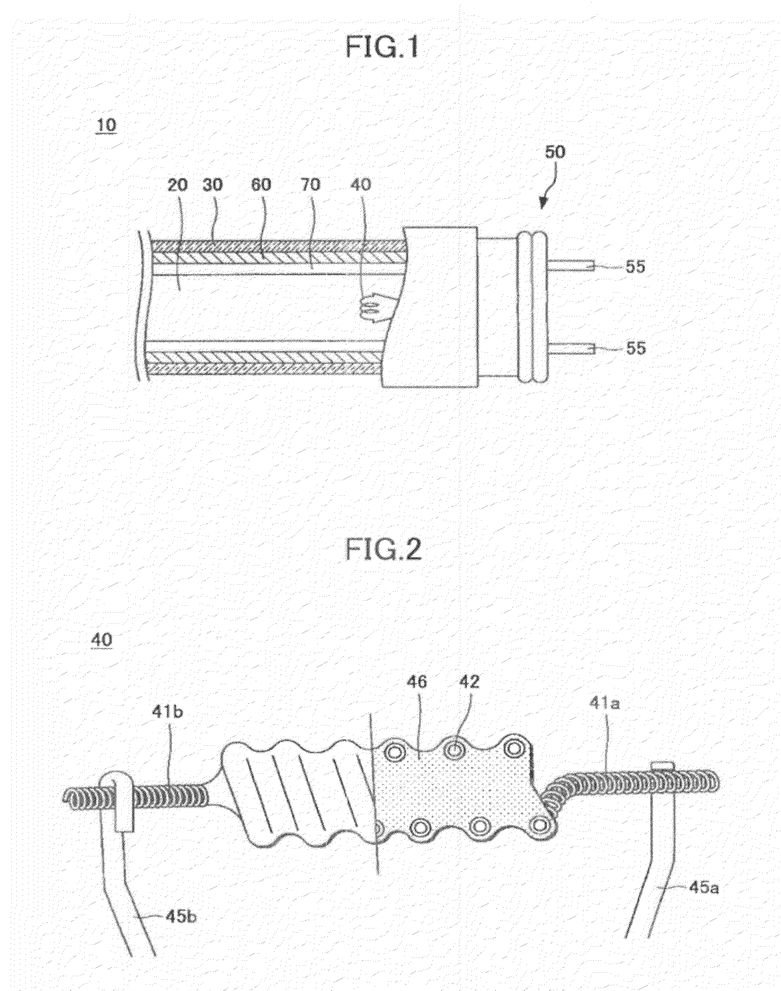

FIG. 1 is an enlarged view of a partially cut-away cross-sectional view of a straight tube fluorescent lamp as an example of a fluorescent lamp, which is an example of a discharge lamp to which the present invention is preferably applicable. FIG. 2 schematically illustrates an example of a structure of an electrode contained in the fluorescent lamp. Although the left-side portion of the fluorescent lamp is not illustrated in FIG. 1, it is clear for a person skilled in the art that this portion has the same structure as the right-side portion of the fluorescent lamp as illustrated.

As illustrated in FIG. 1, the fluorescent lamp 10 includes a tubular bulb 30, which is formed of glass and has a discharge space 20, an electrode 40, and a plug 50.

A protection film 60 and a phosphor 70 are provided on an inner surface of the bulb 30. Discharge gas is enclosed in the discharge space 20, the discharge gas containing a rare gas, and, for example, argon gas containing mercury is used for the discharge gas. The protection film 60 plays a roll of preventing the inner wall of the fluorescent lamp from being blackened by preventing sodium contained in the bulb 30 from being eluted to suppress creation of a compound of mainly mercury and sodium.

The plug 50 is provided on both ends of the fluorescent lamp 10 to support the bulb 30, and has pin parts 55.

The electrode 40 is sealed in both ends of the bulb 30. The electrode 40 includes a coil-like filament 42 and an emitter 46 provided to cover the filament 42. As a material of the filament 42, for example, tungsten (W), molybdenum (Mo), nickel (Ni), niobium (Nb), etc., may be used.

More specifically, as illustrated in FIG. 2, the electrode 40 includes two leg parts 41a and 41b, which are also the ends of the filament 42, and conductive support lines 45a and 45b are connected to the leg parts 41a and 41b, respectively. These support lines 45a and 45b are electrically connected directly or through lead wires to the pin parts 55 of the plug 50, respectively.

It should be noted that the structure of the electrode 40 is a mere example, and it is clear for a person skilled in the art that the electrode 40 can have other structures. For example, although the leg parts 41a and 41b of the electrode 40 are exposed in FIG. 2, the leg parts 41a and 41b may be covered by the emitter 46 similar to other positions of the filament 42.

In the fluorescent lamp 10, when a voltage is applied across the both electrodes 40 (only one is illustrated in FIG. 1), the electrode (cathode side) 40 is heated, and electrons (thermal electrons) are emitted from the emitter 46 heated to a high temperature. The emitted electrons move to the other electrode (anode side) 40, and, thereby, a discharge is started. Subsequently, when electrons flowing by the discharge collide with mercury atoms encapsulated in the discharge space 20 of the bulb 30, the mercury atoms are excited and ultraviolet lights are emitted when the excited mercury returns to the ground state. When the thus-emitted ultraviolet lights are irradiated to the phosphor 70 of the bulb 30, visible lights are generated from the phosphor 70. According to the above-mentioned series of phenomena, visible lights are caused to be radiated from the fluorescent lamp 10.

Here, in a case of a conventional fluorescent lamp, as a material for an emitter of an electrode, alkaline earth metal oxides, such as barium oxide (BaO), strontium oxide (SrO), or a calcium oxide (CaO), are used. This is because an alkaline earth metal oxide usually has a low work function, and can promote thermal electron emission by application of a small voltage.

However, there is a problem pointed out conventionally that an emitter formed of an alkaline earth metal oxide material is easily worn with passage of use time. It is considered that this is because (1) an alkaline earth metal oxide usually has a high vapor pressure at a high temperature, and (2) adhesiveness between an alkaline earth metal oxide and a filament is not good.

For example, barium oxide (BaO) has a melting point and a boiling point of about 1923° C. and about 2000° C., respectively, and calcium oxide (CaO) has a melting point and a boiling point of about 2572° C. and about 2850° C., respectively, and thus, the melting point and the boiling point of each of the materials are close to each other. Thus, it is assumed from those physicality values that the alkaline earth metal oxides have a relatively high vapor pressure at a high temperature.

In a fluorescent lamp having only a conventional material as an emitter, an emitter may be consumed for a relatively short period of time because the emitter heated at a high-temperature may be evaporated during usage of the fluorescent lamp due to an influence of (1), and the emitter may be omitted from a filament due to an influence of (2).

It should be noted that if such a consumption of an emitter occurs, there may be a problem in that a light-emitting efficiency (more specifically, a thermal electron emission efficiency) is decreased. Additionally, if consumption of an emitter becomes severe, a part of a filament may be exposed, and, thereby, a burnout of an electrode may occur easily. As a result, there may be a problem that a service life of the fluorescent lamp is shortened.

On the other hand, according to the fluorescent lamp 10 of the present embodiment, the emitter 46 of the electrode 40 includes a mayenite compound.

The mayenite compound is a general term referring to 12CaO.7Al₂O₃ having a cage (basket) structure (hereinafter, may be referred to as “C12A7”) and a compound (isomorphic compound) having a crystalline structure equivalent to C12A7. Usually, a mayenite compound has a feature that a work function is relatively low.

Moreover, a mayenite compound has a feature that a vapor pressure is relatively low, and as mentioned in detail below, it has been confirmed by the present inventors that a mayenite compound is relatively stable under a high temperature even it exceeds 1100° C. Further, the present inventors reached completion of the present invention by having found that a mayenite compound has a feature that adhesiveness with a filament is relatively good.

Therefore, by using a mayenite compound as a material of an emitter, the problem that the emitter being heated at a high temperature is evaporated or omitted during use of a fluorescent lamp is reduced, and, thereby, it becomes possible to suppress wear of the emitter significantly. Further, the conventional problem is reduced in that, when a mayenite compound is used for an emitter, a cut of an electrode occurs due to exposure of a filament because wear of an emitter is suppressed, which results in shortening of a service life of a fluorescent lamp.

(Details of Each Member of the Fluorescent Lamp of the Present Embodiment)

Next, a description is given in detail of the electrode 40 and the phosphor 70 of the fluorescent lamp according to the present embodiment. It should be noted that with respect to the members such as the bulb 30, the plug 50 and the protection film 60, specifications thereof are sufficiently clear for a person skilled in the art, and descriptions thereof will be omitted.

(Electrode 40)

Generally, a mayenite compound contains oxygen ions in a cage, and, particularly, the oxygen ions are referred to as “free oxygen ions”.

However, the mayenite compound used as the emitter 46 for the electrode 40 of the present embodiment may be one in which a part or all of the “free oxygen ions” are replaced by electrons other than the one having the “free oxygen ions”. Hereinafter the mayenite compound of which a part or all of the “free oxygen ions” are replaced by electrons may be referred to as “conductive mayenite”. It should be noted that a part or all of the “free oxygen ions” may be replaced by anions. As for such an anion, there are, for example, halogen ion, hydrogen anion, oxygen ion, hydroxide ion, etc.

Especially in the present application, a mayenite compound of which a part of free oxygen ions is replaced by H⁻ ions is referred to as “hydrogenated mayenite compound”. In the “hydrogenated mayenite compound”, a H⁻ ion density is preferably 1.0×10¹⁵ cm⁻³ or more, and more preferably, 1.0×10²⁰ cm⁻³. This is because, if the H⁻ ion density is high, the thermal electron emission performance of an electrode and further the discharge current density become high, which causes an arc discharge being generated easily at the electrode. It should be noted that the theoretical maximum of H⁻ ion density is 2.3×10²¹ cm⁻³.

The electron density of the “conductive mayenite” is 1.0×10¹⁵ cm⁻³ or more, and, more preferably, 1.0×10¹⁹ cm⁻³ or more, and, further preferably, 1.0×10²¹ cm⁻³ or more. Thereby, emitter and also the entire electrode can have excellent conductivity, which enables heating the entire electrode more uniformly. Additionally, in this case, the secondary electron emission performance can be higher and the ultraviolet light emitting efficiency is further improved, which provides an effect that the discharge voltage is further reduced. It should be noted that the theoretical maximum of electron density is 2.3×10²¹ cm⁻³.

It should be noted that, in the present embodiment, the electron density of the (conductive) mayenite compound means a measured value which is calculated according to measurement by an electron spin resonance apparatus, or a measured value of a spin density calculated by measurement of an absorption coefficient. Generally, it is good to perform the measurement using an electron spin resonance apparatus (ESR apparatus) if the measured value of spin density is lower than 10¹⁹ cm⁻³, and if it exceeds 10¹⁸ cm⁻³, it is good to calculate the electron density as mentioned below. First, a measurement is carried out of an intensity of light absorption by electrons inside a cage of the (conductive) mayenite compound to acquire the absorption coefficient at 2.8 eV. Subsequently, a quantitative determination of the electron density of the (conductive) mayenite compound is carried out using that the obtained absorption coefficient is in proportion to the electron density. Moreover, if the (conductive) mayenite compound is powder and it is difficult to carry out the measurement of a transmission spectrum by a photometer, a diffuse reflectance spectrum is measured using an integrating sphere so that the electron density of the (conductive) mayenite compound is calculated from the value acquired according to the Kubelka-Munk method.

In the present embodiment, as long as the mayenite compound has a crystal structure equivalent to the C12A7 crystal structure, which includes calcium (Ca), aluminum (Al) and oxygen (O), a part or all of atoms of at least one kind that is selected from calcium (Ca), aluminum (Al) and oxygen (O) may be replaced by other atoms or atomic groups. For example, a part of calcium (Ca) may be replaced by atoms, such as magnesium (Mg), strontium (Sr), barium (Ba), lithium (Li), sodium (Na), chromium (Cr), manganese (Mn), cerium (Ce), cobalt (Co), nickel (Ni), and/or copper (Cu). Moreover, a part of aluminum (Al) may be replaced by silicon (Si), germanium (Ge), boron (B), gallium (Ga), titanium (Ti), manganese (Mn), iron (Fe), cerium (Ce), praseodymium (Pr), scandium (Sc), lantern (La), yttrium (Y), europium (Eu), yttrbium (Yb), cobalt (Co), nickel (Ni), terbium (Tb), etc. Moreover, oxygen of a cage frame may be replaced by nitrogen (N), etc.

The mayenite compound is preferably a 12CaO.7Al₂O₃ compound, a 12SrO.7Al₂O₃ compound, a mixed crystal compound of those, or an isomorphic compound of those.

Although it is not limited to those in the present embodiment, compounds (1) to (4) mentioned below are taken into consideration as a mayenite compound.

(1) Calcium magnesium aluminate (Ca_{1-y}Mg_{y})₁₂Al₁₄O₃₃ or calcium strontium aluminate (Ca_{1-z}Sr_{z})₁₂Al₁₄O₃₃ in which a part of calcium (Ca) which forms a frame of C12A7 is replaced by magnesium (Mg) or strontium (Sr). It should be noted that y and z are preferably 0.1 or less.

(2) Ca₁₂Al₁₀Si₄O₃₅ which is a silicon substitution type mayenite.

(3) For example, Ca₁₂Al₁₄O₃₂:2OH⁻ or Ca₁₂Al₁₄O₃₂:2F⁻ in which free oxygen ions in a cage are replaced by cations, such as H⁻, H₂⁻, H²⁻, O⁻, O₂⁻, OH⁻, Cl⁻, Br⁻, S²⁻, or Au⁻. Because such a mayenite compound has high heat resistance, it is suitable for manufacturing a fluorescent lamp that requires sealing at a temperature exceeding 400° C.

(4) For example, Wadalite Ca₁₂Al₁₀Si₄O₃₂:6Cl⁻ in which both anions and cations are replaced.

It should be noted that although the emitter 46 may be formed solely by a mayenite compound in the present embodiment, it may further contain other additives. As for other additives, there are oxides of alkaline earth metals. As an oxide of alkaline earth metal, barium oxide (BaO), strontium oxide (SrO), or calcium oxide (CaO) is desirable. Other additives are added so that a ratio in the total mass of the emitter 46 falls in a range of 1 wt % to 60 wt %, particularly, 1.5 wt % to 40 wt %. If the emitter contains a mayenite compound and such an oxide simultaneously, an excellent light-emitting efficiency can be obtained over a large temperature range from a low-temperature area (˜about 800° C.) to a high-temperature area (˜about 1300° C.).

In the present embodiment, the filament 42 of the electrode 40 preferably contains tungsten (W), molybdenum (Mo), nickel (Ni) or niobium (Nb). Especially, it is more preferable to contain tungsten (W) or molybdenum (Mo).

On the other hand, the structure of the filament 42 of the electrode 40 is not limited to a specific structure, and the filament 42 may have, for example, a coil-shape. In this case, the filament 42 may have a so-called “double-coil structure” or “triple-coil structure” other than a so-called “single-coil structure”. Alternatively the filament 42 may have a “quadruple-coil structure”.

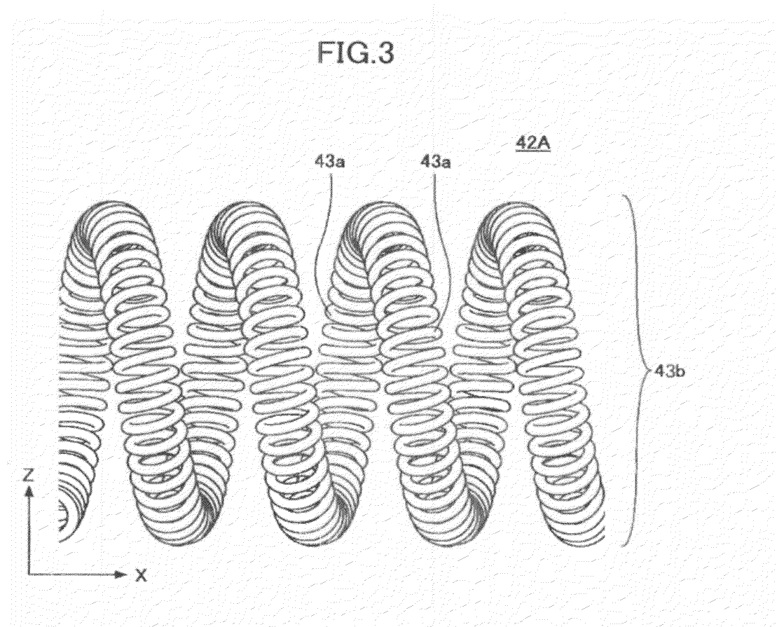

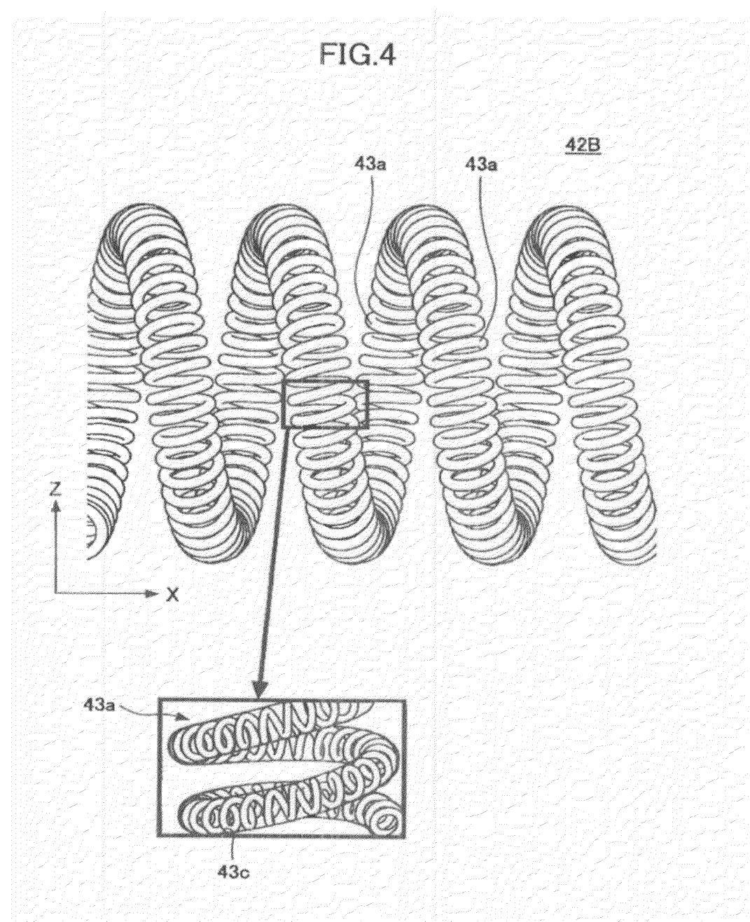

FIGS. 3 and 4 schematically illustrate modes of filaments of the “double coil structure” and the “triple coil structure”, respectively.

As illustrated in FIG. 3, in a case of a filament 42A of the “double coil structure”, a micro spiral structure 43a of which a diameter of a single turn is about 0.1 mm to 0.7 mm extends spirally, and, thereby, a macro spiral structure of which a diameter of a single turn is about 1 mm to 3 mm is formed along the X direction of FIG. 3 as a whole.

On the other hand, a filament 42B of the “triple coil structure” is illustrated in FIG. 4. However, in FIG. 4, in order to maintain clearness of drawing, details are not described correctly and, for this reason, the structure of the “triple coil structure” appears to be the same as that of FIG. 3. However, as illustrated by being partially enlarged in a rectangular frame indicated by an arrow in FIG. 4, in the case of the “triple coil structure”, each of the frames constituting the micro spiral structure 43a of FIG. 3 is formed by a finer spiral structure 43c extending spirally.

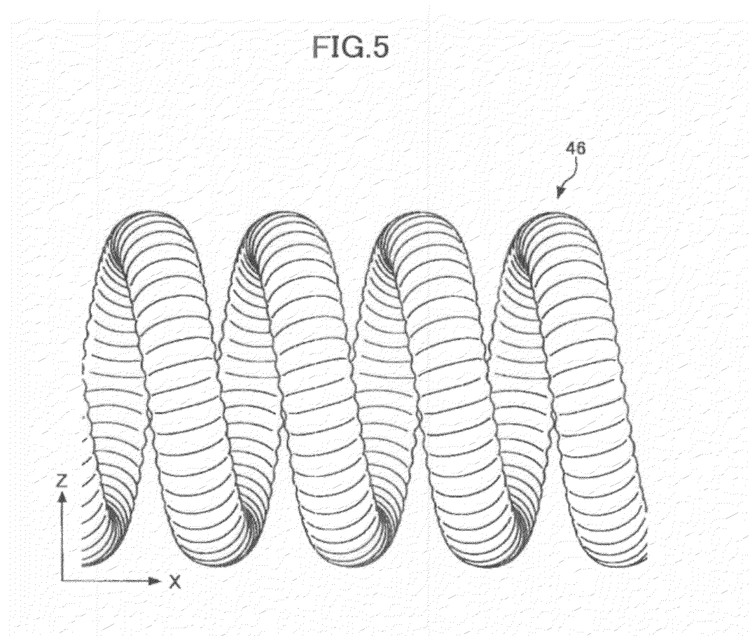

An example of an electrode structure is schematically illustrated in FIG. 5. In the example of FIG. 5, a filament 42A of the “double coil structure” is covered by the emitter 46.

It should be noted that the emitter having a mayenite compound is not necessarily provided to the entire electrode. For example, the emitter having the mayenite compound may be provided to a location where a temperature goes up, for example, the support lines indicated by 45a and 45b, a floating shield ring (not illustrated), a stem part (not illustrated), etc., besides a portion of the filament.

(Phosphor 70)

As a phosphor 70, for example, an europium activated yttrium oxide phosphor, a cerium terbium activated lanthanum phosphate phosphor, an europium activated strontium halophosphate phosphor, an europium activated barium magnesium aluminate phosphor, an europium manganese activated barium magnesium aluminate phosphor, a terbium activated cerium aluminate phosphor, a terbium activated cerium magnesium aluminate phosphor, and an antimony activated calcium halophosphate phosphor may be used solely or in mixture.

It should be noted that with respect to the fluorescent lamp 10, a configuration, a size, a watt number and a color and color rendering property of the light emitted by the fluorescent lamp are not limited specifically. With respect to a configuration, it is not limited to a straight tube as illustrated in FIG. 1, and, for example, may be a shape such as a circular shape, a bicyclic shape, a twin shape, a compact shape, a U-shape, a light bulb shape, etc. With respect to a watt number, for example, it may be several watts to several hundreds watts. With respect to a size, it may be a 4-type˜a 110-type. With respect to a light color, for example, there are a daylight color, a day white color, a white color, a warm white color, an electric bulb color, etc.

(Manufacturing Method of the Electrode for Fluorescent Lamps)

Next, a description is given of a manufacturing method of the electrode 40 used for the fluorescent lamp 10 according to the present embodiment.

The electrode 40 used for the fluorescent lamp 10 according to the present embodiment is manufactured roughly by a step of preparing a filament and a step of providing an emitter containing a mayenite in at least a portion of the filament.

A description is given below of a method of manufacturing an electrode through a process of applying a slurry on a filament.

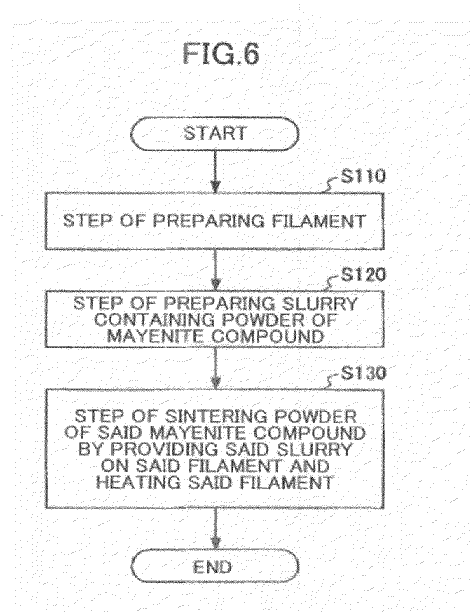

FIG. 6 is a flowchart schematically illustrating such a method for manufacturing the electrode 40 according to the present embodiment.

As illustrated in FIG. 6, the manufacturing method of the electrode 40 according to the present embodiment includes a step (step 110: S110) of preparing a filament, a step (step 120: S120) of preparing a slurry containing powder of a mayenite compound, and a step (step 130: S130) of providing the above-mentioned slurry on the above-mentioned filament, heating the above-mentioned filament, and sintering the powder of the above-mentioned mayenite compound.

A description is given below of each step in detail.

(Step 110)

A filament is prepared first. As a filament material, tungsten (W) or molybdenum (Mo) is used as mentioned above. Although there is no special limitation in the structure of the filament, a coil shape structure, particularly, the above-mentioned double coil structure or triple coil structure are usually used. Besides, a single coil structure or a quadruple coil structure ma be used.

(Step 120)

Next, a slurry for the emitter is prepared according to the method mentioned below.

First, a mayenite compound powder having an average particle diameter of about 1 to 10 μm is prepared. Especially, the average particle diameter of the powder is preferably 2 μm or more and 6 μm or less. It should be noted that if the average particle diameter is smaller than 1 μm, the powder is condensed and it becomes difficult to make the powder finer, and if it is 10 μm or larger, it is hardly carried by the filament.

In a usual case, the mayenite compound powder is prepared by coarse-powdering a mayenite compound raw material and further grinding the coarse powder to a fine powder. A stamp mill, an automatic mortar, etc., may be used for the coarse-powdering of the raw material, and the material is crushed until an average particle diameter becomes about 20 μm. In order to crush the coarse powder until the fine powder having the above-mentioned average particle diameter, a ball mill, a bead mill, etc., may be used.

Next, the prepared powder is added to a solvent together with a binder and agitated to prepare a slurry. As a binder, either an organic binder or an inorganic binder may be used. As an organic binder, for example, nitro cellulose, ethyl cellulose, polyethylene oxide, methyl cellulose, hydroxylpropyl methyl cellulose, carboxy methyl cellulose, hydroxy ethyl cellulose, polyvinyl alcohol, polyacrylic acid soda, polyacrylic amide, polyvinyl butyral, polyethylene, polypropylene, polystyrene, ethylene-acetic acid vinyl copolymer, acrylic resin, polyamide resin, etc., may be used. Moreover, as an inorganic binder, for example, a silicate soda base, a metal alkoxide base, etc., may be used. Moreover, as a solvent, butyl acetate, terpineol, alcohol expressed by a chemical-formula CₙH₂ₙ₊₁OH (n=1˜4) may be used.

If, for example, ethyl cellulose is used, a blending amount of the binder is preferably 40 volume % or less with respect to the above-mentioned prepared powder. A binder is not necessarily used in an application method such as a spin coat, and a dispersing agent may be added. The dispersing agent destroys an aggregate of powder to improve the despersibility. As a dispersing agent, for example, fatty acid, ester phosphate, synthetic surface-active agent, benzenesulfonic acid, etc., may be used. If ester phosphate is used, a blending amount of the dispersing agent is preferably 0.01 weight % to 10 weight % with respect to the above-mentioned prepared powder. A binder and a dispersing agent may be used together.

(Step 130)

Next, the prepared slurry is applied to the filament. There is no limitation in the method of application, and, for example, a spray method, a spin coat method, a dip coat method, or a method of applying the slurry to a desired position using a dispenser may be used.

Next, the filament on which the slurry is applied is held under a temperature of 200° C. to 800° C. for 20 minutes to 1 hour in order to eliminate the binder. However, the elimination of the binder may be carried out simultaneously with a sintering process mentioned below.

Next, the filament is held at a high-temperature in order to sinter the powder. Thereby, an electrode equipped with a filament covered by an emitter containing mayenite is obtained. The temperature of sintering is in a range of, for example, 600° C. to 1415° C. Moreover, although depending on the temperature, the time to hold at a high-temperature is, for example, 10 minutes to 2 hours. The sintering process is performed under an inert gas atmosphere such as nitrogen gas, argon gas, etc., or in a vacuum.

Here, if the electrode is used for a predetermined fluorescent lamp, the sintering process of the powder may be performed by previously attaching a filament to a bulb of the fluorescent lamp and supplying a current to the filament. In this case, an advantage can be obtained that the electrode is not needed to be provided to the fluorescent lamp later.

Moreover, in a case of providing a conductive mayenite compound to the filament, it is desirable to set the atmosphere of the sintering process to a reducing atmosphere. Here, the reducing atmosphere means an atmosphere or a depressurized environment in which a reducing agent exists in a portion contacting the atmosphere and an oxygen partial pressure is 10⁻³ Pa or lower. As a reducing agent, for example, powder of carbon or aluminum may be mixed into the mayenite compound, or mixed into the raw material (for example, calcium carbonate and aluminum oxide) of the mayenite compound when producing the mayenite compound. Moreover, carbon, calcium, aluminum, or titanium may be provided to a portion contacting the atmosphere. The atmosphere preferably has an oxygen partial pressure of 10⁻³ Pa or lower, and, more preferably, an oxygen partial pressure of 10⁻⁵ Pa or lower, and, further preferably, 10⁻¹⁰ Pa or lower, and, particularly preferably, 10⁻¹⁵ Pa. An atmosphere of which oxygen partial pressure exceeds 10⁻³ Pa is not preferable because it is possible that a sufficient conductivity cannot be provided to the mayenite compound. Additionally, a heat treatment temperature is preferably in a range of 600° C. to 1415° C. The heat treatment temperature is preferably 1000° C. to 1370° C., and, more preferably, 1200° C. to 1350° C., and, further preferably, 1300° C. to 1350° C. If the heat treatment temperature is lower than 600° C., it is possible that a sufficient conductivity cannot be provided to the mayenite compound. Moreover, if the heat treatment temperature is higher than 1415° C., melting of the mayenite compound advances and there is a possibility that a desired electrode form is not acquired. A time to hold at the above-mentioned temperature is preferably 5 minutes to 60 minutes, more preferably, 10 minutes to 50 minutes, and, further preferably, 15 minutes to 40 minutes. If the holding time is less than 5 minutes, it is possible that a sufficient conductivity cannot be obtained. Moreover, if the holding time is increased, there is no problem in the properties but it is within 60 minutes in consideration of reducing the manufacturing time. The heat treatment under such a reducing atmosphere is explained as an example as a method of applying a heat treatment in an electric furnace, which is capable of controlling an atmosphere, by locating a shaped material of powder of the mayenite compound in a carbon made vessel having a lid.

Moreover, if a hydrogenated mayenite compound is provided to the filament, it is desirable to set the atmosphere of the above-mentioned sintering process to a hydrogen containing atmosphere. For example, an electrode having a filament covered by a hydrogenated mayenite compound can be obtained by holding a filament provided with a slurry at a temperature in a range of 600° C. to 1415° C. under a hydrogen containing atmosphere.

In the explanation of the above-mentioned manufacturing method, the electrode according to the present embodiment has been explained with an example of a case where the emitter is formed by only a mayenite compound. On the other hand, in a case of forming an emitter containing a mixture of a mayenite compound and an alkaline earth metal oxide, for example, a powder of desired alkaline earth metal oxide carbonic acid salt is added to a mayenite compound powder in the process of the above-mentioned step S120 to prepare a mixture powder. However, in a case of using such a mixture powder as a starting material, it is needed to perform a treatment to eliminate carbon dioxide (CO₂) generated in the process of reaction. For example, an emitter can be provided to the filament by attaching the filament to the fluorescent lamp in a state where the mixture powder is applied to the filament and, in that state, maintaining inside the lamp tube in an inert atmosphere or in a vacuum state and holding the filament at a temperature ranging from 700° C. to 1100° C. for 10 minutes to 30 minutes. Thereafter, necessary gas is filled into the internal space of the bulb, and sealing the both ends of the bulb, thereby forming the fluorescent lamp.

For example, an emitter may be provided on the filament by directly applying a powder for an emitter to the filament without using a slurry and performing a sintering process. Alternatively, a mayenite compound may be directly formed on the filament without applying a powder. As such a method, for example, a physical vapor deposition method such as a vacuum vapor deposition, an electron beam vapor deposition, a sputtering, a thermal spray, etc., may be used.

Moreover, when manufacturing directly a fluorescent lamp having an electrode, for example, a filament may be incorporated previously in the fluorescent lamp, and a mayenite compound may be applied to the filament and the powder for an emitter may be sintered by supplying electric current to the filament. Alternatively, the filament may be embedded in a vessel in which the powder for an emitter is filled, and the powder for an emitter may be sintered by supplying electric current to the filament. When carrying out the sintering process of the emitter by supplying electric current, a temperature of the filament by the electric current supply is in a range from 600° C. to 1415° C., and preferably 800° C. to 1370° C., and more preferably 1000° C. to 1350° C., and further preferably in a range of 1200° C. to 1300° C. If the temperature of the filament is lower than 600° C., the mayenite compound may not sufficiently adhere to the metal filament, which may reduce an adhesion strength. On the other hand, if the temperature of the filament is higher than 1415° C., melting of the mayenite compound advances and there is a possibility that a desired electrode form is not acquired. A time to maintain at the high-temperature is preferably 5 minutes to 60 minutes, and more preferably 10 minutes to 50 minutes, and further preferably 15 minutes to 40 minutes. If the maintaining time is less than 5 minutes, it is possible that adhesion strength of the mayenite compound is reduced, and there is a risk of the emitter falling off during use. Moreover, if the maintaining time is increased, there is no problem in the properties but it is preferably within 60 minutes in consideration of reducing the manufacturing time.

Further, in the above-mentioned method, if the temperature for firing the emitter is 1200° C. to 1415° C., the temperature is equal to the temperature at which the mayenite compound is synthesized. Accordingly, for example, if C12A7 is used as a mayenite compound, powders of a calcium compound and an aluminum compound may be prepared with an oxide converted molar ratio of 12:7, and these are mixed using equipments such as a ball mill and the obtained mixture powder may be applied to the filament and sintered. According to the present method, manufacturing of a mayenite compound and sintering of the mayenite compound can be performed simultaneously.

By the way, conventionally, when an emitter is formed by alkaline earth metal oxides, such as barium oxide (BaO), the following manufacturing method has been used.

(i) A slurry containing a carbonate powder of an alkaline earth metal (for example, BaCO₃) is applied to a filament.

(ii) An electric current is supplied to the filament within a bulb of a fluorescent lamp to heat the filament. Thereby the carbonate powder decomposes into an oxide, and an emitter made of an alkaline earth metal oxide is formed on the filament.

However, according to such a method, there is a problem in that an appropriate oxide emitter cannot be obtained if the decomposition of the carbonate is insufficient. Moreover, according to this method, carbon dioxide (CO₂) is generated in a heating process, and if the carbon dioxide (CO₂) remains in the fluorescent lamp, there is a higher possibility of giving a bad influence to the performance of the fluorescent lamp due to a possible chemical change of mercury.

On the other hand, according to the present embodiment, if the emitter is foamed of only a mayenite compound, there is no generation of carbon dioxide (CO₂) because a carbonic acid salt of alkaline-earth metals is not contained as a start material at the time of forming the emitter, and, thus, a subordinate effect that a possibility that a bad influence is given to the performance of the fluorescent lamp is suppressed is acquired.

Moreover, according to the present embodiment, there is provided a fluorescent lamp including: a bulb having an internal space in which mercury and a rare gas are filled; a phosphor provided on an inner surface of the bulb; and an electrode configured to generate and maintain a discharge in the above-mentioned internal space, wherein the electrode includes a filament and an emitter which is formed of a mayenite compound and is provided on the filament. Specifically, the fluorescent lamp illustrated in FIG. 1 is provided. The fluorescent lamp has the bulb 30 having an inner surface to which the protective film 60 and the phosphor 70 are applied, and mercury (Hg) gas for exciting phosphor and argon (Ar) as a rare gas are filled in the inner space of the bulb 30. Furthermore, the electrode 40 for generating and maintaining a discharge is provided in the above-mentioned internal space. The mayenite compound is provided on the filament of the electrode 40. The mayenite compound may be provided not only on the filament part but also on a place where a temperature is raised, such as, for example, the support lines indicated by 45a and 45b in FIG. 2, a floating shield ring (not illustrated), and a stem part (not illustrated). In such a fluorescent lamp, because wearing of the emitter is suppressed, the fluorescent lamp can be used stably for a long period of time.

### EXAMPLES

Next, a description is given of examples of the present embodiment.

### Practical Example 1

An electrode having a tungsten filament covered by an emitter of a conductive mayenite compound was formed according to a method mentioned below.

(Synthesis of the Mayenite Compound)

After mixing the powders of calcium carbonate (CaCO₃) and aluminum oxide (Al₂O₃) so that a molar ratio is 12:7, the mixture powder was maintained in an atmosphere at 1300° C. for 6 hours. Then, the obtained sintered material was crushed by an automatic mortar to obtain a powder (hereinafter, referred to as a powder A1). A particle size of the powder A1 was measured by a laser diffraction scattering method (SALD-2100, manufactured by Shimazu Corporation). An average particle size was 20 μm. Additionally, it was confirmed by an X-ray analysis that the powder A1 had solely 12CaO.7Al₂O₃ and the powder A1 was a mayenite compound. Further, an electron density of the powder A1 was acquired by performing measurements by an ESR apparatus, and the electron density was less than 1×10¹⁵ cm⁻³.

(Preparation of Electrode)

Next, the powder A1 was further crushed by a wet ball mill using isopropyl alcohol as a solvent. The crushed powder was suctioned and filtered, and dried in air of 80° C. to obtain a fine powder (hereinafter, referred to “powder A2”). An average particle size of the powder A2 was measured by the above-mentioned laser diffraction scattering method and the average particle size was 5 μm. Butyl carbitol acetato, terpineol and nitrocellulose were added to the powder A2 so that a weight ratio of the powder A2:butyl carbitol acetato:terpineol:nitrocellulose is 6:2:1.85:0.15, and this was kneaded by an automatic mortal and further kneaded by a centrifugal kneader, and a past A3 was obtained.

Subsequently, the past A3 was dropped onto a coil part of a tungsten filament (W-460100 manufactured by the Nilaco Corporation) having a double coil structure. Further, the filament was maintained at 150° C. and a sample A4 was obtained by removing an organic solvent in the paste.

Thereafter, the sample A4 was put in a carbon container, and the carbon container was put in an electric furnace inside of which a vacuum was formed with an oxygen partial pressure of 10⁻³ Pa, and the carbon container was maintained at 1350° C. for 30 minutes. According to the above-mentioned process, an electrode having a filament on which an emitter is deposited in a film form was obtained (hereinafter, referred to as “electrode according to the practical example 1). At this time, a weight of the deposited emitter was 8 mg. Moreover, it was confirmed by an X ray diffraction that the electrode according to the practical example 1 includes only the 12Cao.7Al₂O₃ structure, and was a mayenite compound.

With respect to the electrode according to the practical example 1, a diffuse reflectance spectrum was measured, and an electron density of the emitter was acquired by the Kubelka-Munk method. As a result, the electron density of the emitter was 5×10¹⁹ cm⁻³, and it was confirmed that the emitter of the electrode was a conductive mayenite compound.

### Practical Example 2

After pressure-shaping the above-mentioned powder A1 into a pellet form, the powder A1 was heated at 1350° C. and a sintered body was obtained. The obtained sintered body was put in a carbon container with a lid, and the carbon container was put in an electric furnace inside of which a vacuum was formed with an oxygen partial pressure of 10⁻³ Pa or lower, and the carbon container was maintained at 1300° C. for 2 hours in a state where inside the container was maintained at a low oxygen partial pressure. Thereafter, the container was cooled and a sample B1 was obtained. Further, the sample B1 was crushed using a dry ball mill to form a powder B2. Upon measurement by the above-mentioned laser diffraction scattering method, an average particle size of the powder B2 was 5 μm.

Then, the powder B2 was sprinkled onto the coil part of the above-mentioned tungsten filament in an atmosphere. Thereafter, an electric current was supplied to the filament in a vacuum having an oxygen partial pressure of 10⁻³ Pa or lower. The voltage was 6V, the temperature of the filament was about 800° C., and the time of supplying an electric current was 15 minutes.

Thereby, an electrode having a filament on which an emitter is deposited in a film faun was obtained (hereinafter, referred to as “electrode according to the practical example 2”). At this time, a weight of the deposited emitter was 12 mg. Moreover, it was confirmed by an X-ray diffraction that the electrode according to the practical example 2 has only the 12Cao.7Al₂O₃ structure, and was a mayenite compound.

The diffuse reflectance spectrum of the mayenite compound of the electrode according to the practical example 2 was measured, and an electron density was acquired by the Kubelka-Munk method. The electron density was 5×10¹⁸ cm⁻³, and it was confirmed that the emitter of the electrode was a conductive mayenite compound.

### Practical Example 3

After the above-mentioned powder A2 was sprinkled onto the coil part of the above-mentioned tungsten filament, an electric current was supplied to the filament in a vacuum having an oxygen partial pressure of 10⁻³ Pa. The voltage was 6V, the temperature of the filament was about 800° C., and the time of supplying an electric current was 15 minutes.

Thereby, an electrode having a filament on which an emitter is deposited in a film faun was obtained (hereinafter, referred to as “electrode according to the practical example 3”). At this time, a weight of the deposited emitter was 7 mg. Moreover, it was confirmed by an X-ray diffraction that the electrode according to the practical example 3 has only the 12CaO.7Al₂O₃ structure, and was a mayenite compound.

An electron density of the mayenite compound of the electrode according to the practical example 3 was acquired by measurements by an ESR apparatus, and the electron density was less than 1×10¹⁵ cm⁻³, and it was found that the emitter of the electrode according to the practical example 3 was a non-conductive mayenite compound.

### Practical Example 4

A paste A5 was produced by replacing the powder A2 by the powder B2 (refer to the practical example 2) in the production of the above-mentioned paste A3 (refer to the practical example 1). 4 g of the paste A5 and 4 g of a powder of barium carbonate (manufactured by Kanto Chemical Co., Inc.) were mixed in an alumina mortal in an atmosphere to obtain a mixture powder. The mixture powder was applied to the coil part of the above-mentioned tungsten filament, and an electric current was supplied to the filament in a vacuum having an oxygen partial pressure of 10⁻³ Pa or lower. The voltage was 8V, the temperature of the filament was about 1000° C., and the time of supplying an electric current was 15 minutes.

Thereby, an electrode having a filament on which an emitter is deposited in a film form was obtained (hereinafter, referred to as “electrode according to the practical example 4”). This emitter contains the mayenite compound and BaO. At this time, a weight of the deposited emitter was 13 mg. Moreover, it was confirmed by an X-ray diffraction that the electrode according to the practical example 4 includes the 12CaO.7Al₂O₃ structure and barium oxide (BaO), and was a mixture of the mayenite compound and barium oxide (BaO).

A diffuse reflectance spectrum of the mayenite compound of the electrode according to the practical example 4 was measured, and an electron density was acquired by the Kubelka-Munk method. The electron density was 7×10¹⁸ cm⁻³, and it was found that the mayenite compound of the electrode according to the practical example 4 was a conductive mayenite compound.

### Comparative Example 1

The powder of barium carbonate (manufactured by Kanto Chemical Co., Inc.) was applied to the coil part of the above-mentioned tungsten filament, and an electric current was supplied to the filament in a vacuum. The voltage was 8V, the temperature of the filament was about 1000° C., and the time of supplying an electric current was 15 minutes.

Thereby, an electrode having a filament on which an emitter is deposited in a film form was obtained (hereinafter, referred to as “electrode according to comparative example 1”). As a result of an X-ray diffraction, it was found that, in the electrode according to comparative example 1, the emitter was formed of only barium oxide (BaO). A weight of the deposited emitter was 17 mg.

(Adhesiveness)

Using the samples of a cutout piece of each electrode acquired by the above-mentioned methods, a state of adhesiveness between the filament and the emitter were observed by FE-SEM apparatus (S-4300 manufactured by Hitachi, Ltd.). A rotary cutter made of a stainless steel was used to cut the electrodes.

In the case of the electrodes according to the practical examples 1 through 4, a clear gap was not recognized in an interface between the filament and the emitter, and the adhesiveness therebetween was good. On the other hand, in the case of the electrode according to comparative example 1, an exfoliation occurred in the emitter when cutting the electrode, and it was unable to prepare any sample for observation. Accordingly, it is assumed that, in the case of the electrode according to comparative example, adhesiveness between the filament and the emitter is not good.

(Evaluation of Thermal Electron Emission Property)

The thermal electron emission property of each electrode was evaluated according to the following method.

First, one of the above-mentioned electrodes (hereinafter, referred to as “sample electrode”) and a collector electrode are placed in a vacuum chamber so that the collector electrode is placed at a distance of 7 cm from the sample electrode, and air in the vacuum chamber was evacuated to form a vacuum of about 10⁻⁴ Pa.

Then, an electric current was supplied to the filament of the sample coil in a state where a voltage of 1 kV is applied across the both electrodes. Then, thermal electrons emitted by the sample electrode (actually, an electric current value flowing in the collector electrode) when the sample electrode was heated to a predetermined temperature were measured.

The temperature of the sample electrodes was set to 900° C., 1000° C., 1100° C., 1200° C., and 1300° C. The temperature of the sample electrode was measured by a radiation thermometer (TR-630 manufactured by Minolta Co., Ltd.)

Results obtained for each electrode are collectively indicated in Table 1.

TABLE 1

| | emitter | electrode temperature | | | | |
|---|---|---|---|---|---|---|
| sample | material | 900° C. | 1000° C. | 1100° C. | 1200° C. | 1300° C. |
| Practical | Conductive | ◯ | ◯ | ◯ | ◯ | ◯ |
| Example 1 | Mayenite | | | | | |
| Practical | Conductive | ◯ | ◯ | ◯ | ◯ | ◯ |
| Example 2 | Mayenite | | | | | |
| Practical | Non- | ◯ | ◯ | ◯ | ◯ | ◯ |
| Example 3 | conductive | | | | | |
| | Mayenite | | | | | |
| Practical | Conductive | ◯ | ◯ | ◯ | ◯ | ◯ |
| Example 4 | Mayenite + BaO | | | | | |
| Comparative | BaO | ◯ | ◯ | ◯ | X | X |
| Example 1 | | | | | | |

In Table 1, indication of ◯ represents that an electric current due to thermal electron emission exceeded 10 μA in experiments. X represents that a measurement was not achieved because the emitter provided to the filament evaporated rapidly and stable thermal electron emission did not occur.

It can be appreciated from the results that, in the cases of electrodes according to the practical examples 1 through 4, a good thermal electron emission property can be obtained at any temperature from 900° C. to 1300° C. On the other hand, in the case of the electrode according to comparative example 1, when the filament temperature exceeded 1200° C., it was not able to measure a current due to thermal electron emission accurately because the emitter was worn rapidly and a stable thermal electron emission was not achieved.

It was found from those results that the electrodes according to the practical examples 1 through 4 have good high-temperature stability in a temperature range higher than 1200° C.

(Arc Discharge Test)

An arc discharge test was carried out for each sample electrode according to the following method.

First, one of the above-mentioned sample electrodes was placed in a vacuum chamber as a cathode, and a tungsten electrode was also placed in the vacuum chamber as an anode at a position separated from the sample electrode by a distance of 5 mm, and, then, air inside the vacuum chamber was evacuated to form a vacuum of about 10⁻⁴ Pa. Then, Ar gas was introduced into the vacuum chamber to set the inside pressure to 338 Pa. Further, a voltage of 100 V was applied across the sample electrode (cathode) and the tungsten electrode (anode).

Subsequently, while the voltage was applied across the electrodes, an electric current is supplied to the sample electrode to generate an arc discharge. When generating an arc discharge, an amount of electric current supplied to the sample electrode was adjusted so that an arc discharge current becomes 0.2 A, and a temperature of the sample electrode at that time was measured by the above-mentioned radiation thermometer.

After the discharge was caused to continue for 1 hour, the experiment was ended and a change in the emitter was observed visually. Moreover, the surface of the sample electrode after the test was observed using a FE-SEM apparatus. Further, a weight of each sample electrode was measured before and after the test, and a weight reduction amount of each sample electrode was evaluated.

The results obtained by the experiments are indicated collectively in Table 2.

TABLE 2

| | | | | Weight |
|---|---|---|---|---|
| | Emitter | Electrode | Result of | Change |
| Sample | Material | Temperature | Visual Check | Amount |
| Practical | Conductive | 1100° C. | No Change | N.D |
| Example 1 | Mayenite | | | |
| Practical | Conductive | 1100° C. | No Change | N.D |
| Example 2 | Mayenite | | | |
| Practical | Non- | 1100° C. | No Change | N.D |
| Example 3 | conductive | | | |
| | Mayenite | | | |
| Practical | Conductive | | | |
| Example 4 | Mayenite + | 900° C. | No Change | 1 mg |
| | BaO | | | |
| Comparative | BaO | 800° C. | Drop off | 5 mg |
| Example 1 | | | | |

As indicated in Table 2, as a result of visual observation, there was no large change in the emitters of the electrodes according to the practical examples 1 through 4. On the other hand, in the electrode according to the comparative example 1, it was observed that the emitter was partially dropped off. Additionally, it was observed that many black attached materials, which are considered to be scattered from the emitter, had adhered on a periphery of the electrode after the test. Moreover, it was found from the measurement results of the weight reduction amount that a weight reduction was hardly recognized in the electrodes according to the practical examples 1 through 4, whereas the weight of the electrode according to comparative example was reduced.

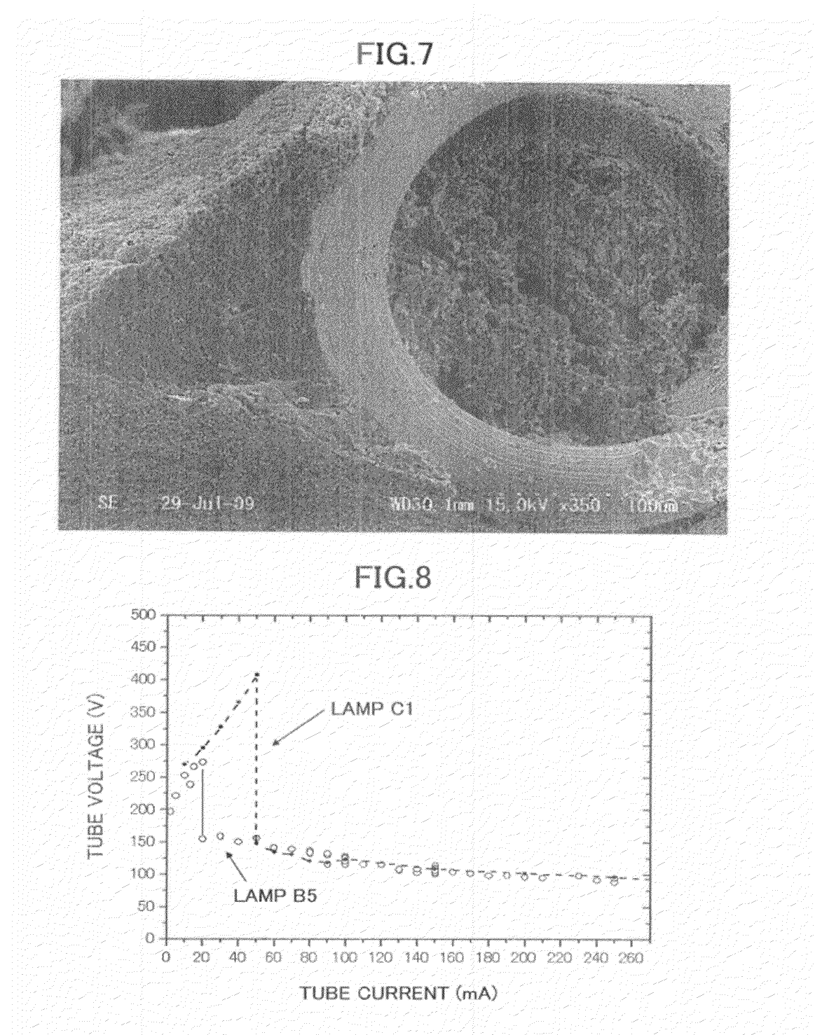

FIG. 7 illustrates a state of the electrode according to the practical example 1 after the arc discharge test (a cross-sectional view of the electrode). As illustrated in FIG. 7, in the electrode according to the practical example 1, it is appreciated that a good adhesiveness was maintained between the filament and the emitter even after the test. This is because, when a mayenite compound is subjected to a heat treatment at 800° C. or higher, sintering begins and the mayenite compound is changed from a powder to a solid and the mayenite compound is fixed to the filament at 600° C. or higher. It was found that, also in the electrodes of other practical examples, the filament and the emitter provide a good adhesiveness even after the test.

### Practical Example 5

(Comparison of Electrode Temperature)

Butyl carbitol acetato, terpineol and acrylic resin were added to the above-mentioned powder B2 so that a weight ratio of the powder B2:butyl carbitol acetate:terpineol:acrylic resin is 10:5.4:2.7:0.9, and this was kneaded by an automatic mortal and further kneaded by a centrifugal kneader, and a paste B3 was obtained.

Subsequently, the paste B3 was dropped onto a tungsten filament having a double coil structure (W-460100 manufactured by Nilaco company). Further, the filament was maintained at 150° C. and a sample B4, which is a tungsten filament (coil) on which surface a conductive mayenite compound adheres, was obtained by removing an organic solvent in the paste. The carried amount of the conductive mayenite was about 1 mg.

A lamp was fabricated using the sample B4. The lamp has the same structure as that illustrated in FIG. 1 except for the phosphor being not applied. The lamp has a tube length of 430 mm, an electrode interval of 365 mm and a tube diameter of 30 mm. After evacuating gas inside the lamp tube to be about 10⁻⁴ Pa by using an evacuation tube previously provided in a middle of the tube of the lamp, the acrylic resin contained in the paste B3 was removed by supplying an electric current and maintain the filament temperature at about 700° C. for 2 minutes. Further, the evacuation pipe was once cut and liquid mercury was introduced into the lamp tube by drop treatment, and, thereafter, the evacuation pipe was connected again and gas inside the tube was evacuated. After inside of the lamp tube was set to about 10⁻⁴ Pa, Ar gas was introduced into the tube and an inner pressure was set to 665 Pa and the evacuation pipe was sealed, thereby fabricating a lamp (hereinafter, may be referred to as lamp B5).

When the lamp B5 was driven using a direct-current power supply and a Tesla coil, a tube current-tube voltage characteristic indicated in FIG. 8 was obtained. Here, the tube current and the tube voltage represent a current and a voltage between electrodes of the lamp B5, respectively. The Tesla coil is a resonance transformer for generating a radio-frequency/high-voltage, and used to cause a discharge to start easily.

When the tube current exceeded 20 mA, the electrode surface shone significantly, and an arc spot was faulted. Furthermore, from the fact that the tube voltage rapidly dropped from 275 V to 150 V, it was confirmed that a hot cathode operation was carried out in the lamp B5 in which a conductive mayenite compound is applied to the filament. Additionally, the minimum tube current for carrying out the hot cathode operation was 20 mA.

The temperature of the arc spot was measured using two-color type fiber radiation thermometer (LumaSense Technologies GmbH, ISQ-5). When the tube current was 100 mA, the temperature of the arc spot was 1406° C. When maintaining the tube current of 100 mA for 5 minutes, there was no large change in the bulb 30 in the vicinity of the cathode. Furthermore, the lamp B5 was disassembled and the filament was taken out. The weight of the conductive mayenite compound carried by the filament was 1 mg, and it was found that there is no change and the cathode was not degraded.

### Comparative Example 2

A lamp was fabricated by the same method as the practical example 5 using a tungsten filament which did not carry a conductive mayenite compound (hereinafter, may also be referred to as a lamp C1). When the lamp C1 was driven using a direct-current supply and a Tesla coil, a tube current-tube voltage characteristic was obtained.

When the tube current exceeded 50 mA, the electrode surface shown significantly, and an arc spot was formed. Further, it was confirmed that a hot cathode operation was achieved in the lamp C1 because the tube voltage dropped rapidly from 405 V to 148 V. Moreover, a minimum tube current for achieving the hot cathode operation was 50 mA. Additionally, the arc spot temperature when the tube current was 100 mA was measured, and the arc spot temperature was 1842° C.

When the tube current was maintained at 100 mA for 5 minutes, a black material was attached to the bulb 30 in the vicinity of the cathode, and bulb 30 was blackened. It was found that this was a material generated by sputtering of the tungsten filament and the cathode was significantly degraded (sputtered).

### Practical Example 6

(Comparison of Firing Voltage)

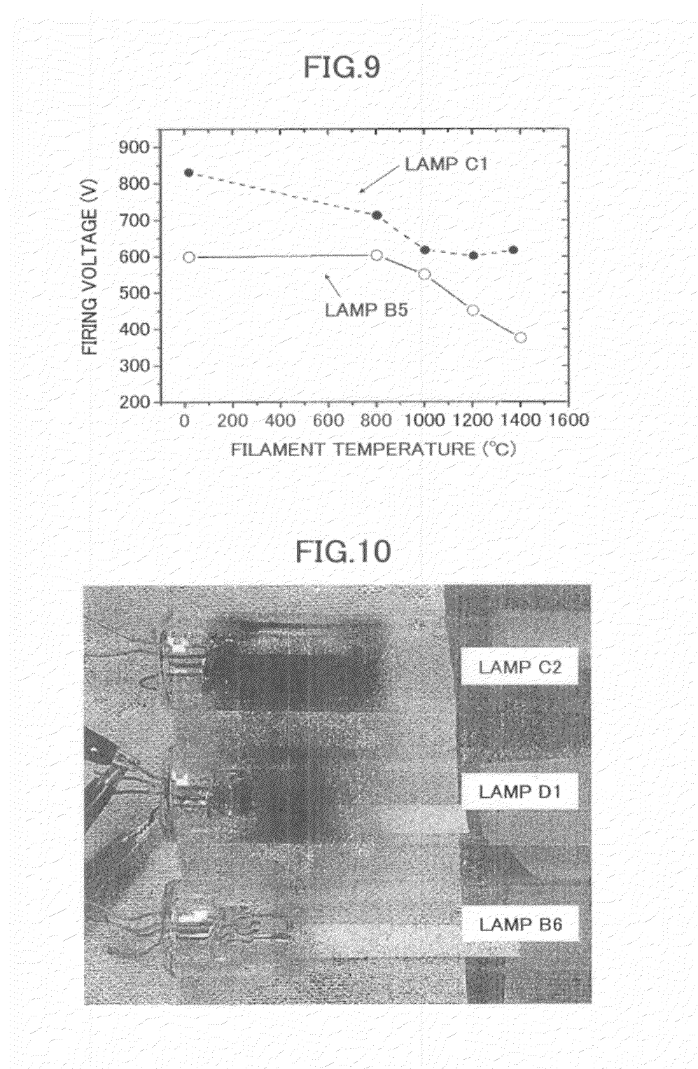

The lamp B5 and a ballast resistance of 1 kΩ were connected in series, and a firing voltage was measured by applying a direct-current voltage to the circuit. The ballast resistance plays a roll of preventing generation of an excessive current when starting a discharge and stabilizing the entire circuit. The firing voltage at a room temperature was 598 V. Further, the filament temperature was caused to change by heating by supplying an electric current. The filament temperature was measured in the same manner as the practical example 5. The firing voltage was measured without using the Tesla coil while increasing the filament temperature. FIG. 9 illustrates a graph in which firing voltages in a range of the filament temperature from a room temperature to 1400° C.

### Comparative Example 3

With respect to the lamp C1, the filament temperature and the firing start voltage were measured by the same method as the practical example 6. The firing voltage at a room temperature was 831 V. FIG. 9 illustrates a graph in which firing voltages in a range of the filament temperature from a room temperature to 1400° C. while changing the filament temperature by heating by supplying an electric current were plotted.

It was found that the lamp B5 has a firing voltage lower than that of the lamp C1 in the entire temperature range, and it was also found that when using the tungsten filament carrying a conductive mayenite compound, the firing voltage can be set lower than a case of only the tungsten filament, thereby being able to reduce power consumption.

### Practical Example 7

(Comparison of Sputter Marks)

A tungsten filament carrying barium oxide was fabricated in the same manner as comparative example 1.

The weight of the barium oxide was 3 mg. A lamp was fabricated by the same method as the practical example 5 using the tungsten filament carrying barium oxide (hereinafter, may also be referred to as “lamp D1”). Further, a lamp B6, which was fabricated by the same structure and method as the lamp B5, and a lamp C2, which was fabricated by the same structure as the lamp C1, were prepared.

The lamps B6, C2 and D1 were turned on and maintained with a tube current of 300 mA for 1 hour, and thereafter, the bulbs 30 in the vicinity of the cathodes are observed. Black material was attached and they were blackened as illustrated in FIG. 10. This was the tungsten filament being sputtered and attached to the bulbs 30, and it was considered that the cathode is deteriorated more as an area of blackened portion is larger. The size of the area of blackened portion is C2>D1>B6, and it was found that the tungsten filament carrying a conductive mayenite is hardly deteriorated.

### Practical Example 8

(Fabrication of Conductive Mayenite by Arc Discharge)

A lamp was fabricated by the same method as the practical example 5 using the sample A4, which is a tungsten filament carrying a mayenite compound (hereinafter, may also be referred to as lamp A6). The lamp A6 was caused to perform an arc discharge with a tube current of 250 mA for 5 minutes, and, thereafter, the filament was observed. The carried mayenite compound was blackened. The lamp A6 was disassembled and the black material was sampled, and a crystal and a composition ratio were investigated. It was found that the black material is a mayenite compound.

Further, an electron density of the black mayenite compound was measured by ESR apparatus. The electron density was 5×10¹⁸ cm⁻³ or more. It was found that that the mayenite compound according to the practical example 8 was changed by an arc discharge from a non-conductive mayenite compound into a conductive mayenite compound. Accordingly, a part of the process of the practical example 1 was omitted. Specifically, it was found that the heat treatment, in which a tungsten filament carrying a non-conductive mayenite compound is put in a carbon container and heated at 1350° C. under a vacuum of 10⁻³ Pa or less for 30 minutes, can be omitted, and thereby it is very useful.

### Practical Example 9

(Simulation Calculation of Sputter Resistance of BaO and Mayenite Compound)

A sputtering rate of a mayenite compound was calculated according to the Monte Carlo method with respect to a case where the Ar atoms are vertically incident on a sample (target). The TRIM code (refer to J. F. Ziegler, J. P. Biersack, U. Littmark, “The Stopping and Range of Ions in Solid”, vol. 1 of series “Stopping and Range of Ions in Matters”, Pergamon Press, New York (1984)) was used for the calculation. For comparison purpose, a sputtering rate was also calculated with respect to BaO. The sputtering rate is a number of sputtered target atoms for each incident atom or ion, and it indicates that it is more difficult to be sputtered as the number is smaller.

In the simulation, the densities of the mayenite compound, which is a target, and BaO were set to 2.67 g/cm³ and 5.72 g/cm³, respectively. Moreover, a surface bonding energy, which is an index of coupling between the atoms on the surface of a material, was set to 3.55 eV/atom with respect to the mayenite compound and 3.90 eV/atom with respect to BaO. “eV/atom” used here is a unit indicating an energy value per one atom of a material.

Moreover, a discharge gas of a fluorescent lamp, which is practically used, is a mixture gas containing Ar as a major component. Therefore, in the practical example 9, a simulation was performed with respect to Ar as an incoming atom. The simulation is one that estimates an efficiency of constituent atoms of a mayenite compound or BaO escaping out of a material surface due to sputtering when a kinetic energy of Ar is varied in a range of 0.1 to 1.0 keV.

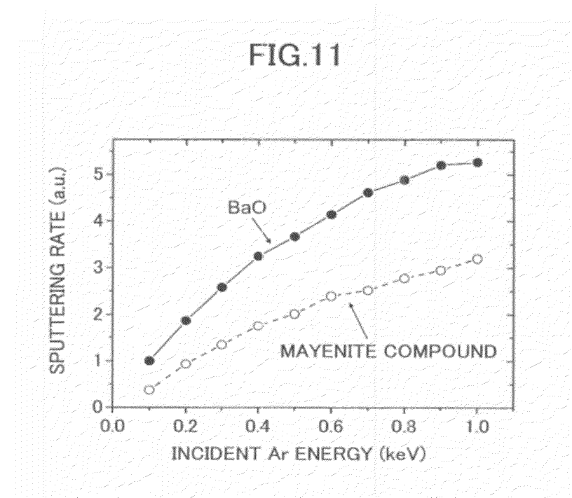

FIG. 11 illustrates calculation results in a case where the sputtering rate of BaO when Ar of 0.1 keV is incident is set to 1. It is illustrated that the sputtering rates of the mayenite compound are below that of Bao in the entire energy area in FIG. 11. It was appreciated from the above that the mayenite compound exhibits sputtering resistance higher than BaO with respect to Ar, which is a discharge gas of a fluorescent gas.

It was appreciated from the above that the electrode having a mayenite compound as an emitter has good adhesiveness as compared to a conventional electrode. Moreover, it was confirmed that wear of an emitter at a time of discharge is suppressed by using an electrode having a mayenite compound.

Although the present invention has been explained in detail and by referring to specific embodiments, it is clear for a person skilled in the art that various changes and modifications can be made without departing from the spirit and scope of the present invention.

The present invention is not limited to the specifically disclosed embodiments, and variations and modifications may be made without departing from the scope of the present invention.

What is claimed is:

1. An electrode for a fluorescent lamp, comprising:
a filament; and
an emitter provided on said filament,
wherein said emitter includes a mayenite compound.

2. The electrode as claimed in claim 1, wherein said mayenite compound includes a conductive mayenite.

3. The electrode as claimed in claim 1, wherein said emitter further contains an alkaline earth metal oxide.

4. The electrode as claimed in claim 3, wherein said alkaline earth metal oxide includes at least one kind of oxide selected from a group consisting of barium oxide (Bao), strontium oxide (SrO) and calcium oxide (CaO).

5. The electrode as claimed in claim 1, wherein said filament contains tungsten (W) or molybdenum (Mo).

6. A fluorescent lamp, comprising:
a bulb having an internal space in which mercury and a rare gas are filled;
a phosphor provided on an inner surface of said bulb; and
an electrode that causes a discharge to be generated and maintained in said internal space,
wherein said electrode is an electrode as claimed in claim 1.

7. A manufacturing method of an electrode for a fluorescent lamp, comprising:
a step of preparing a filament; and
a step of providing an emitter containing a mayenite compound on the filament.

8. The manufacturing method as claimed in claim 7, wherein the step of providing said emitter includes: a step of preparing a slurry containing a powder of the mayenite compound; and a step of heating said filament after providing said slurry on said filament, and causing to sinter said powder of said mayenite compound.

9. The manufacturing method as claimed in claim 7, wherein said mayenite compound includes a conductive mayenite.

10. The manufacturing method as claimed in claim 7, wherein said filament contains tungsten (W) or molybdenum (Mo).
